(19) United States
(12) Patent Application Publication
(10) Pub. No.: US 2008/0301215 A1
(43) Pub. Date: Dec. 4, 2008

(54) NAT (Network Address Translation) traversal methods and systems

(75) Inventor: Bae Huei Wang, Kaohsiung (TW)

Correspondence Address: BIRCH STEWART KOLASCH & BIRCH, PO BOX 747, FALLS CHURCH, VA, 22040-0747, US

(73) Assignee: InterVideo, Digital Technology Corporation

(21) Appl. No.: 11/907,682

(22) Filed: Oct. 16, 2007

(30) Foreign Application Priority Data
May 29, 2007 (CN) 200710106420.8

(51) Int. Cl. G06F 15/16

(52) U.S. Cl. 709/201; 707/3

(57) ABSTRACT

Network Address Translation (NAT) Traversal methods and systems. First, a web-based server is provided. The server comprises a database storing connection information corresponding to at least one application, wherein the connection information comprises a network address and a connection port corresponding to the application. A first host connects to the server to query and obtain the connection information corresponding to the application. The First host connects to a second host comprising the application in a private domain according to the network address and the connection port in the connection information to use the application.

### BACKGROUND OF THE INVENTION

1. Field of the Invention

The disclosure relates generally to network management, and, more particularly to NAT (Network Address Translation) traversal methods and systems.

2. Description of the Related Art

In a network environment, due to specific reasons such as security or asymmetry between network addresses of hosts in the private and public domains, NAT provides translation for communication therebetween. When hosts and applications in the network both have NAT traversal capability, specific hosts or applications in the private domains can be accessed via the Internet.

However, since not all hosts and applications have NAT traversal capability, some hosts and applications can not be accessed externally. In conventional practice, users must upload resources of a private host to a specific and public host in advance. When users need the resources of the private host remotely, they link to the public host to access the resources. In this practice, it takes times for uploading the resources, and the resources cannot be immediately accessed and controlled. The resources on the public and private hosts may contain inconsistencies, thereby increasing management difficulty of resources.

FIG. 1 is a schematic diagram illustrating a conventional NAT traversal mechanism. In FIG. 1, A1˜A5, B1˜B5, C1˜C5 and D1˜D5 are ordinary hosts without NAT traversal capability in the private domains. A, B, C and D are super nodes respectively assigned to ordinary nodes A1˜A5, B1˜B5, C1˜C5 and D1˜D5 in the public domain. A super node means a node having NAT traversal capability. A super node stores a list recording other super nodes with NAT traversal capability. When an ordinary host wants to communicate with a specific host, the ordinary host can transmit communication data to the specific host via the corresponding super nodes in the public domain. For example, when ordinary node A1 wants to communicate with ordinary node C2, super nodes A and C are employed as relay stations to handle the communication between ordinary nodes A1 and C2 since super nodes A and C contain related information of ordinary nodes A1 and C2, respectively. That is ordinary node A1 can transmit data to ordinary node C2 via relay stations A and C, and receive data from ordinary node C2 via relay stations A and C. In this mechanism, since the relay stations are specially set for specific hosts, additional costs for set up are required. Further, when the hosts are changed, related management thereto becomes complex. Additionally, since all communications between the ordinary nodes must be forwarded by the relay stations, the load on the relay stations is heavy, thus reducing the efficiency of the relay stations. When specific relay stations malfunction, the whole service will most likely be suspended.

### BRIEF SUMMARY OF THE INVENTION

NAT traversal methods and systems are provided.

In an embodiment of a NAT traversal method, a web-based server is provided. The server comprises a database storing connection information corresponding to at least one application, wherein the connection information comprises a network address and a connection port corresponding to the application. A first host connects to the server to query and obtain the connection information corresponding to the application. The first host connects to a second host comprising the application in a private domain according to the network address and the connection port in the connection information to use the application.

An embodiment of a NAT traversal system comprises a first host, a second host, and a web-based server. The server comprises a database storing connection information corresponding to at least one application, wherein the connection information comprises a network address and a connection port corresponding to the application. The first host connects to the server via a network to query and obtain the connection information corresponding to the application, and connects to the second host according to the network address and the connection port in the connection information to use the application.

NAT traversal methods and systems may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating a conventional NAT traversal mechanism;

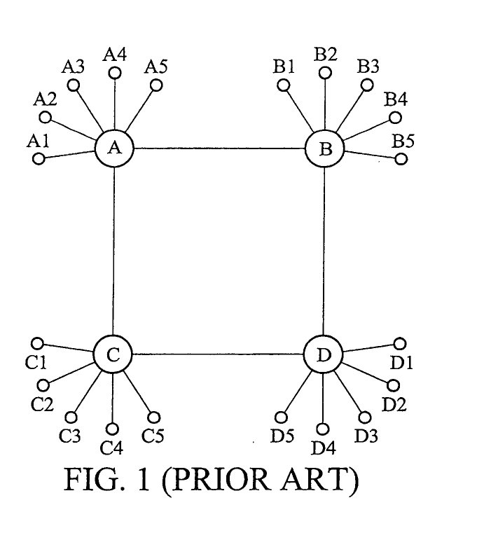

FIG. 2 is a schematic diagram illustrating an embodiment of a NAT traversal system;

FIG. 3 is a schematic diagram illustrating an embodiment of a web-based server;

FIG. 4 shows an embodiment of connection information;

FIG. 5 is a flowchart of an embodiment of a connection information registration

FIG. 6 is a flowchart of an embodiment of a NAT traversal method; and

FIG. 7 shows an embodiment of a NAT traversal example.

### DETAILED DESCRIPTION OF THE INVENTION

NAT traversal methods and systems are provided.

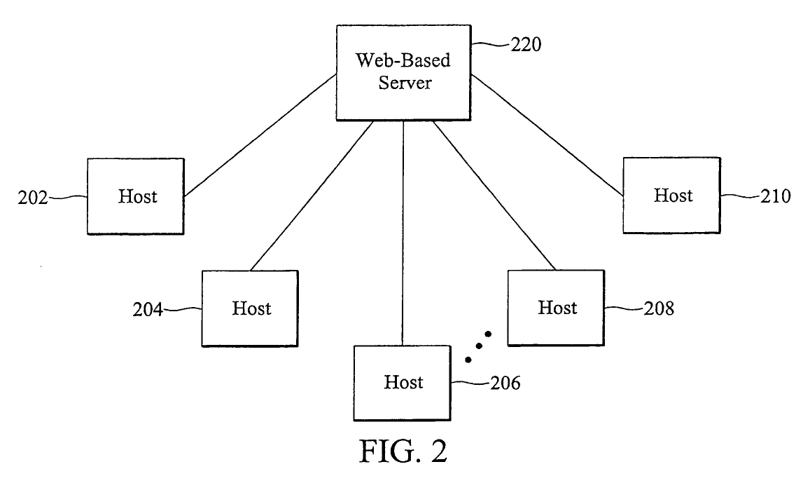

FIG. 2 is a schematic diagram illustrating an embodiment of a NAT traversal

As shown in FIG. 2, the NAT traversal system comprises a web-based server 220, and a plurality of hosts 202, 204, 206, 208 and 210. Each host can couple to the server 220 via the Internet. It is understood that respective hosts may be in different private domains, and the server 220 is in a public domain. Each host has an account with the server 220, registers related information of resources and applications thereon with the server, and sets authority data corresponding thereto. Each host can query related information such as connection information corresponding to a specific application according to server 220 authorization, and connect to a host providing the specific application according to the connection information to use the specific application. It is understood that, in some embodiments, several servers can be provided as stand-bys or to handle different hosts.

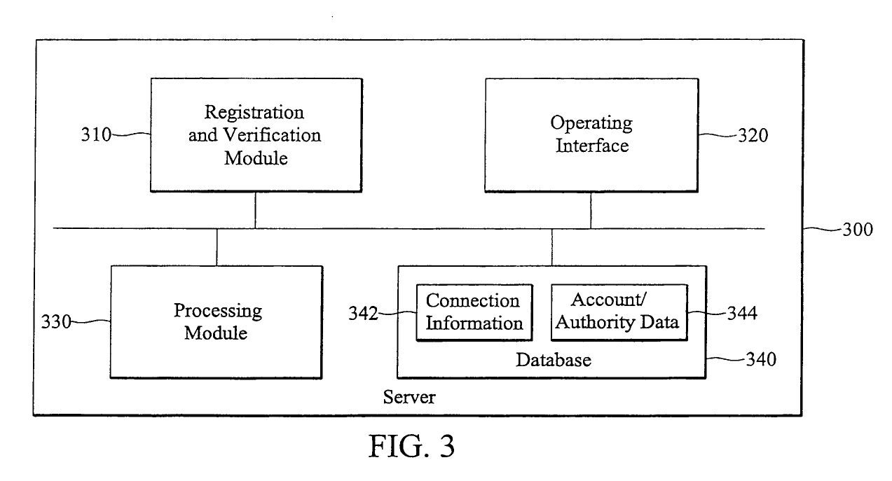

FIG. 3 is a schematic diagram illustrating an embodiment of a web-based server.

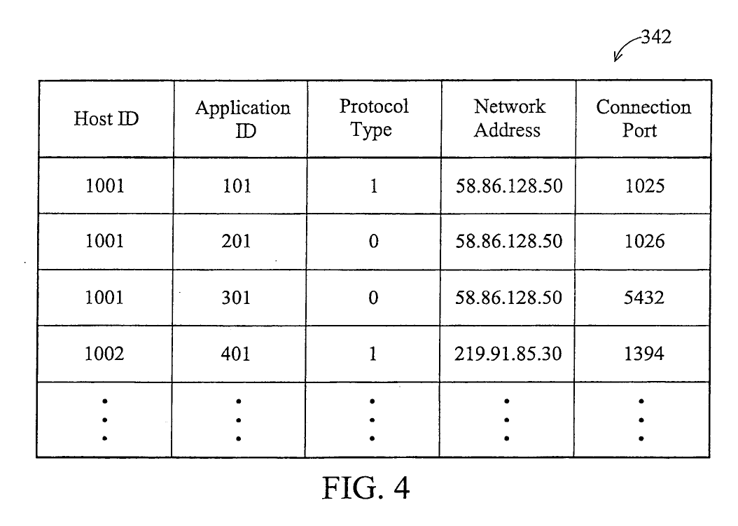

The web-based server 300 comprises a registration and verification module 310, an operating interface 320, a processing module 330, and a database 340. The database 340 stores connection information 342 and account/authority data 344. Hosts can login the server 300 via the operating interface 320, and register and query the connection information 342. FIG. 4 shows an embodiment of connection information. As shown in FIG. 4, the connection information 342 comprises fields containing a host ID, an application ID, a protocol type, a network address, and a connection port. Respective applications that can be accessed by other hosts in a host have a record. In the example in FIG. 4, host IDs 1001 and 1002 represent different hosts. Application IDs 101, 201 and 301 represent different applications on host 1001, such as an FTP (File Transfer Protocol), a media player, a network camera, a device controller, or a live TV playback. Protocol types 0 and 1 represent different communication protocols. For example, 1 represents TCP (Transmission Control Protocol), and 0 represents UDP (User Datagram Protocol). The network address is an IP (Internet Protocol) address of a host after NAT. The connection port is defined by a host to be coupled with a specific application. The registration and verification module 310 receives account registrations (applications) from hosts, and performs related verification operations according to the account/authority data 344 to confirm whether the hosts are valid users of the server 300, and determine access authorization of the hosts concerning related connection information. The processing module 330 performs the information registration and query operations.

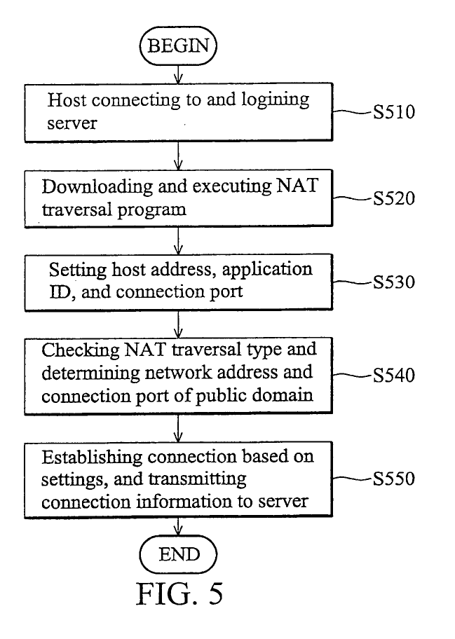

FIG. 5 is a flowchart of an embodiment of a connection information registration method.

In step S510, a host connects to and logs on to a web-based server via the Internet. It is understood that, if the host had registered in the server, the host can directly use its account to log on to the server. If the host is not registered in the server, the host must apply for a new account with the server. When the host logs in, the server verifies the host according to the account/authority data in the database. In step S520, the host downloads and executes a NAT traversal program (not shown in FIG. 3) from the server. It is noted that the NAT traversal program can help the host to proceed with related operations of registration for connection information of an application. In step S530, related settings of the connection information such as the network address of the host in the private domain, application ID and connection port correspond to the application. In step S540, the NAT type is checked, and the network address and connection port in the public domain are determined. In step S550, the server is connected based on the above settings, and the connection information corresponding to the application is transmitted to the server. It is understood that the network address of the host in the private domain is translated into a network address in the public domain after NAT. NAT devices (related devices with the NAT capability, such as router, gateway, switch hub, modem, and others) will record the mapping relationship between the network addresses in the private and public domains, and the connection port corresponding to the application, and transmit the translated network address of the host in the public domain to the server. It is understood that the host can set a querying authorization for the connection information corresponding to the application in the server. For example, the connection information can be provided for all hosts, partial hosts, or the host itself to query. The server stores the connection information and corresponding authority data in the database.

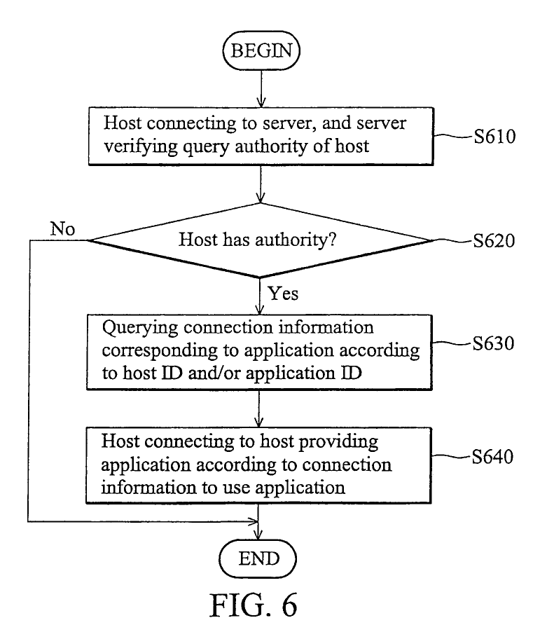

FIG. 6 is a flowchart of an embodiment of a NAT traversal method.

In step S610, a host connects to a web-based server via the Internet, and the serer verifies the host and its query authority. If the host does not has the query authority (No in step S620), the procedure is completed. If the host has the query authority concerning a specific application (Yes in step S620), in step S630, corresponding connection information is queried and obtained according to the host ID and/or application ID to be sought. After the connection information is obtained, in step S640, the host directly connects to a host providing the application according to the connection information to use the application. It is understood that since NAT devices will record the mapping relationship between the network addresses in the private and public domains, and the connection port corresponding to the application, when an access request is received, a host and an application to be accessed can be determined according to the connection port.

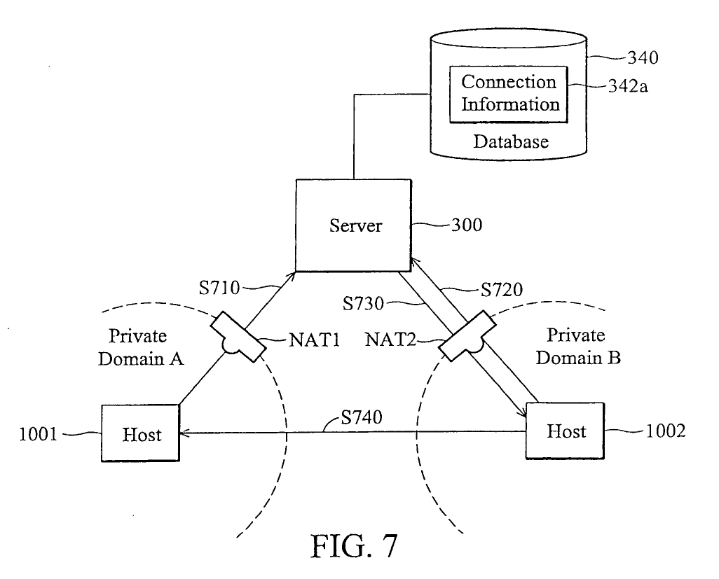

FIG. 7 shows an embodiment of an NAT traversal example. FIGS. 4 and 7 are referred to, to assist in explaining the following example. In this example, host 1001 is in the private domain A, and has a network address and a connection port “192.168.1.1:1234” in the private domain. Host 1001 couples to the public domain via a NAT device NAT 1 having a network address “58.86.128.50” in the public domain. Host 1002 is in the private domain B, and has a network address and a connection port “192.168.1.100:5678” in the private domain. Host 1002 couples to the public domain via a NAT device NAT 2 having a network address “219.91.85.30” in the public domain.

Host 1001 can register connection information 342a corresponding to an FTP application through NAT 1 using the NAT traversal program in advance with the server 300, as the first record shown in FIG. 4 (S710), wherein the host ID is “1001”, the application ID is “101”, the protocol type is “1 (TCP)”, the network address is “58.86.128.50”, and the connection port is “1025”. The server 300 stores the connection information 342a to the database 340. As described, NAT device NAT 1 will record the mapping relationship between the network addresses of host 1001 in the private and public domains, and the connection port corresponding to the application (the connection port is “1025” in this example), and the NAT traversal program will transmit the translated network address of the host in the public domain after NAT 1 to the server. If host 1002 wants to query FTP services in the network environment, it can log in to the server 300, and query related connection information according to specific host IDs and/or application IDs (S720). In this example, host 1002 can input host ID “1001” and/or application ID “101” to query and obtain the connection information 342a corresponding to the FTP application (S730). After the connection information is obtained, host 1002 can directly connect to host 1001 according to the content of the connection information such as protocol type, network address, and connection port to use the FTP application (S740). In this example, host 1002 can connect to host 1001 according to “58.86.128.50:1025” to use the FTP application.

The NAT traversal methods and systems have web-based open architectures with an advantage of noncomplex operations which increase users' motivation for use. Additionally, various applications without the NAT capability can be provided for public via the disclosed NAT traversal methods and systems.

It is understood that, in some embodiments, the connection port corresponding to the application can be periodically modified randomly or manually to enhance the system security.

NAT traversal methods and systems, or certain aspects or portions thereof, may take the form of a program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A NAT (Network Address Translation) traversal method, comprising:
providing a web-based server, wherein the server comprises a database storing connection information corresponding to at least one application, wherein the connection information comprises a network address and a connection port corresponding to the application;
a first host connecting to the server to query and obtain the connection information corresponding to the application; and
the first host connecting to a second host comprising the application in a private domain according to the network address and the connection port in the connection information to use the application.

2. The method of claim 1, wherein the connection information further comprises an application ID corresponding to the application, and the method further comprises a step of the first host querying the connection information corresponding to the application according to the application ID.

3. The method of claim 2, wherein the connection information further comprises a host ID corresponding to the second host, and the method further comprises a step of the first host querying the connection information corresponding to the application according to the host ID and the application ID.

4. The method of claim 1, wherein the connection information further comprises a protocol type, and the method further comprises a step of the first host connecting to the second host according to the protocol type, the network address, and the connection port in the connection information to use the application.

5. The method of claim 1, further comprising the second host connecting to the server, and registering the connection information corresponding to the application with the server.

6. The method of claim 5, wherein the method of the second host registering the connection information with the server comprises the steps of:
the second host downloading and executing a NAT traversal program from the server;
setting the network address and the connection port corresponding to the application; and
establishing a connection with the server via the connection port to transmit the connection information comprising the network address and the connection port to the server.

7. The method of claim 6, further comprising:
checking a NAT type of the second host; and
transmitting the information of NAT type to the server.

8. The method of claim 5, further comprising:
the second host applying for an account with the server; and
the server managing the connection information corresponding to the application of the second host according to the account.

9. The method of claim 1, further comprising:
verifying the first host to determine whether the first host has a query authority corresponding to the application; and
if so, providing the connection information corresponding to the application to the first host.

10. The method of claim 1, wherein the application comprises an FTP (File Transfer Protocol), a media player, a network camera, a device control, or a live TV playback application.

11. A NAT (Network Address Translation) traversal system, comprising:
a second host in a private domain, comprising at least one application;
a web-based server comprising a database storing connection information corresponding to at least one application, wherein the connection information comprises a network address and a connection port corresponding to the application; and
a first host connecting to the server via a network to query and obtain the connection information corresponding to the application, and connecting to the second host according to the network address and the connection port in the connection information to use the application.

12. The system of claim 11, wherein the connection information further comprises an application ID corresponding to the application, and the first host further queries the connection information corresponding to the application according to the application ID.

13. The system of claim 12, wherein the connection information further comprises a host ID corresponding to the second host, and the first host further queries the connection information corresponding to the application according to the host ID and the application ID.

14. The system of claim 11, wherein the connection information further comprises a protocol type, and the first host further connects to the second host according to the protocol type, the network address, and the connection port in the connection information to use the application.

15. The system of claim 11, wherein the second host further connects to the server, and registers the connection information corresponding to the application with the server.

16. The system of claim 15, wherein the second host further downloads and executes a NAT traversal program from the server, sets the network address and the connection port corresponding to the application, and establishes a connection with the server via the connection port to transmit the connection information comprising the network address and the connection port to the server.

17. The system of claim 16, wherein the second host further checks a NAT type thereof, and transmits the information of NAT type to the server.

18. The system of claim 15, wherein the second host further applies for an account with the server, and the server manages the connection information corresponding to the application of the second host according to the account.

19. The system of claim 11, wherein the server further verifies the first host to determine whether the first host has a query authority corresponding to the application, and if so, provides the connection information corresponding to the application to the first host.

20. The system of claim 11, wherein the application comprises an FTP (File Transfer Protocol), a media player, a network camera, a device control, or a live TV playback application.
